(19) United States
(12) Patent Application Publication
(10) Pub. No.: US 2018/0250588 A1
(43) Pub. Date: Sep. 6, 2018

(54) UNIVERSAL GAME CONTROLLER/CONSOLE

(71) Applicant: Jayme Winick, Toronto (CA)

(72) Inventor: Jayme Winick, Toronto (CA)

(21) Appl. No.: 15/910,467

(22) Filed: Mar. 2, 2018

Related U.S. Application Data
(60) Provisional application No. 62/466,193, filed on Mar. 2, 2017.

(51) Int. Cl. A63F 13/24; A63F 13/25; H02J 7/00

(52) U.S. Cl. CPC A63F 13/24; H02J 7/0042; A63F 13/25

(57) ABSTRACT

The Universal Game Controller/Console is an all-in-one mobile gaming console and controller to interface to any screen, particularly mobile devices and tablets.

### FIELD OF THE INVENTION

The present invention relates to game controllers and consoles and more specifically to a game console that is also a controller and operates with various portable devices.

### BACKGROUND OF THE INVENTION

Game controllers and game consoles are unique to the individual game developer and not interchangeable with systems from other game developers.

### SUMMARY OF THE INVENTION

The present invention is a game console which is both a console and controller.

The game console comprises a left controller/console and a right controller/console.

The left controller/console and right controller/console each have a clamping mechanism for attachment to a display screen.

The present invention is also a game console in which a left controller/console and right controller/console together act as a controller for use with a separate display screen.

The game console of the present invention is comprised of a pair of game consoles for use in holding any portable device with a display screen between the pair of game consoles.

The display screen may be a tablet computer or mobile phone.

The left and right controller/consoles of a game console of the present invention are sized to fit in the palm of a left hand and right hand; are slimmer at the midpoint, and additionally comprise play buttons from about the midpoint angling slightly outward to glide pad buttons.

The sealable glide pad has precise positioning ability, does not have any moving parts and does not require contact pressure.

The left controller/console is chargeable and capable of charging the right controller/console.

In an embodiment of the invention, the he left controller/console comprises two tabs with metal contacts which fit into two receiving ports on the right controller/console for receiving charging.

### BRIEF DESCRIPTION OF THE FIGURES

These and other aspects of the present invention will be apparent from the brief description of the drawings and the following detailed description in which:

FIG. 1 is a front view of a Universal Game Controller/Console of the present invention, shown in a first position with a portable device;

FIG. 2 is a front view of a Universal Game Controller/Console of the present invention in a second position;

FIG. 3 is a front view of a Universal Game Controller/Console of the present invention in a third position;

FIG. 4 is a top view of the Universal Game Controller/Console in FIG. 3;

FIG. 5 is a bottom of the Universal Game Controller/Console in FIG. 3;

FIG. 6 is a back view of the Universal Game Controller/Console in FIG. 3;

FIG. 7 is a left side view of the Universal Game Controller/Console in FIG. 3;

FIG. 8 is a right side view of the Universal Game Controller/Console in FIG. 3;

FIG. 9 is a display broadcasting flow chart;

FIG. 10 is a services chart;

FIG. 11 is a software platforms chart;

FIG. 12 is an available services chart;

FIG. 13 is a screenshot—Home;

FIG. 14 is a screenshot—Explore;

FIG. 15 is a screenshot—Live Channels;

FIG. 16a is a screenshot—Create Channels—Game Details; and

FIG. 16b a screenshot—Create Channels—Invite.

### DETAILED DESCRIPTION OF THE INVENTION

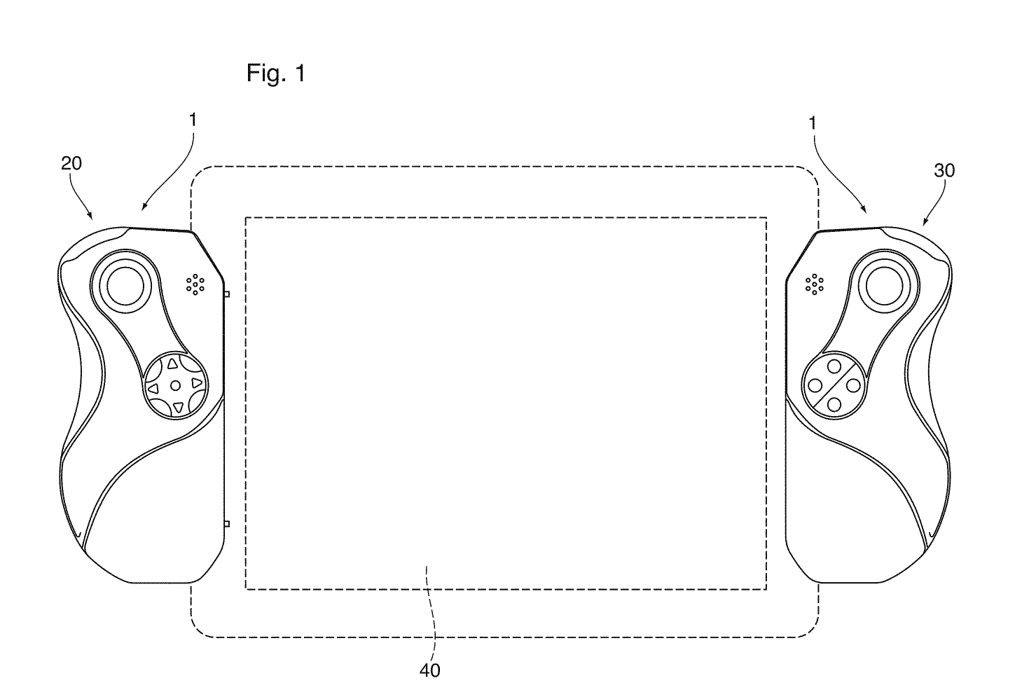

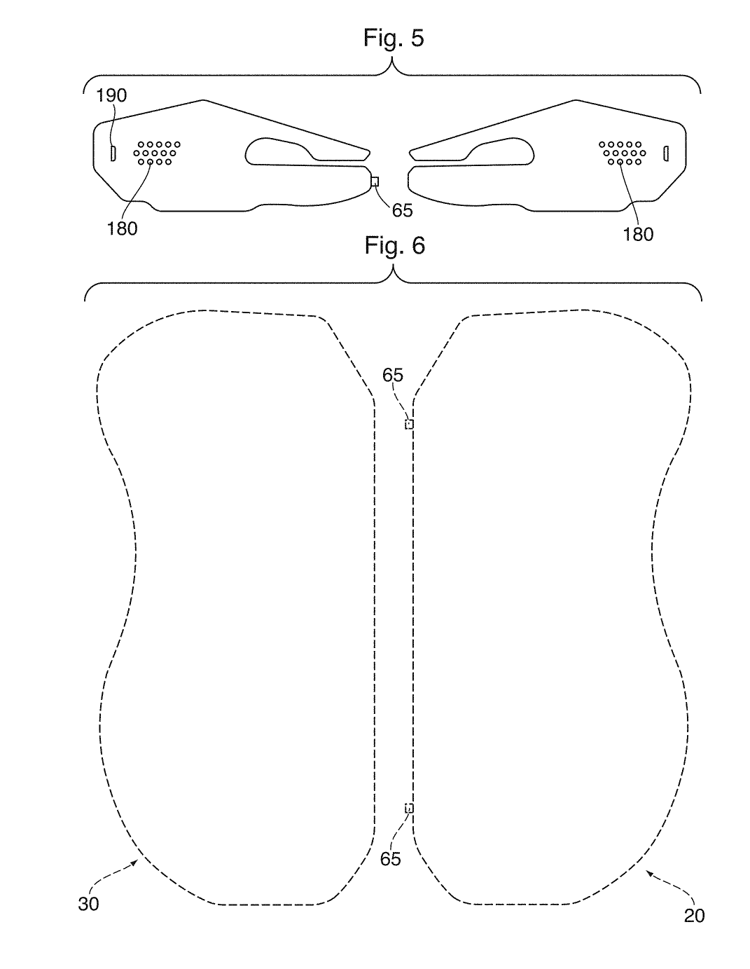

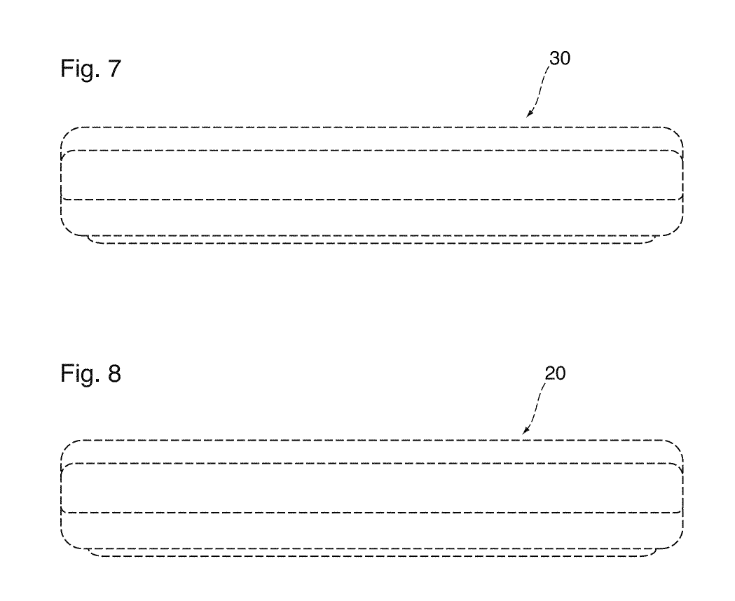

As shown in FIGS. 1-8, the Universal Game Controller/Console 1 of the present invention is an all-in-one mobile gaming console and controller which utilizes any screen and is capable of playing any game. The Universal Game Controller/Console 1 is comprised of a left controller/console 20 and right controller/console 30 capable of clamping onto any screen 40, e.g. smart phone or electronic tablet. As shown in FIG. 1, the Universal Game Controller/Console 1 clamps onto any mobile or tablet 40 and is screen docked to the mobile or tablet device and interacts through wireless technology.

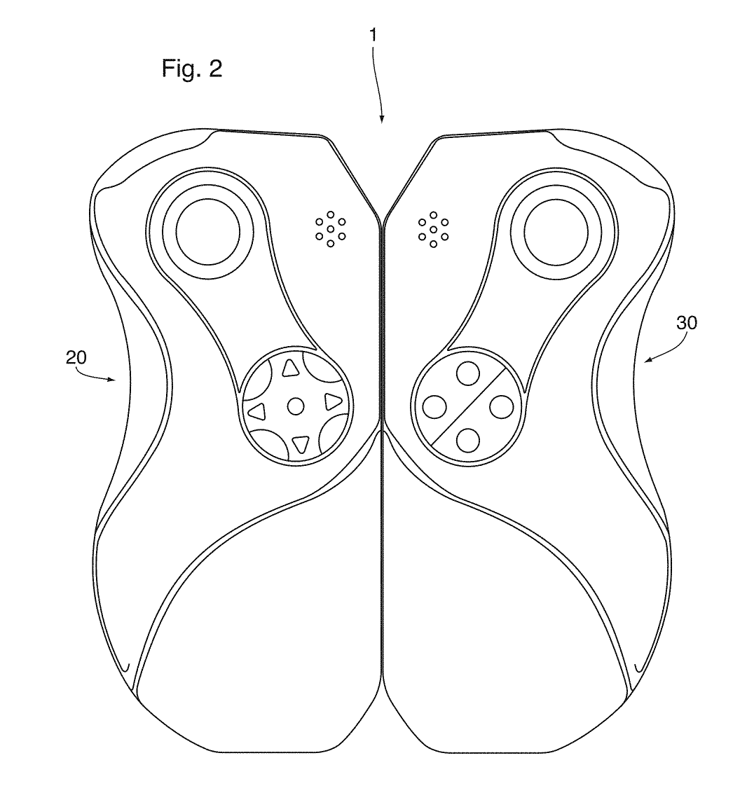

As shown in FIG. 2, the Universal Game Controller/Console 1 is operational for gaming when the left controller/console 20 and right controller/console 30 are joined together and in this case utilizes an independent screen e.g. computer monitor or television screen.

The Universal Game Controller/Console of the present invention does not have a display, but the gamer connect with any smart phone or smart TV through an app.

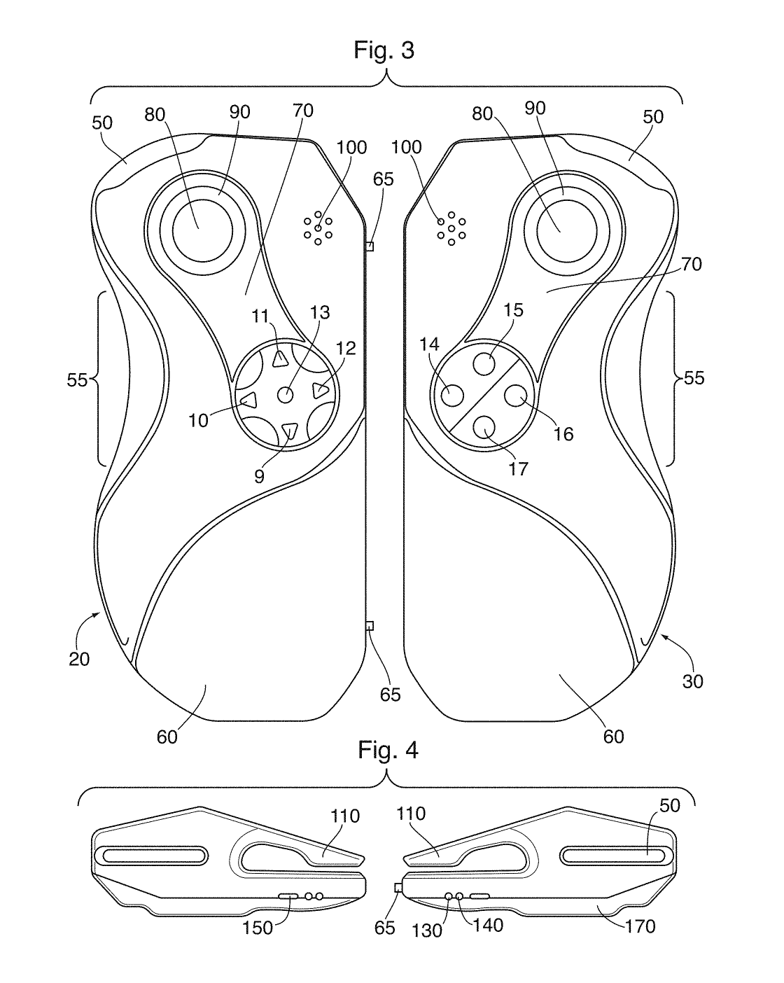

The Universal Game Controller/Console 1 comprising left controller/console 20 and right controller/console 30 is shown at rest in FIG. 3. The game control platform 70 on the left and right controller/console 20, 30 both have a trigger button 50, a glide pad 70 surrounded with LED light 90, palm grip 60 and ergonomic curve 55. The left controller/console 20 additionally comprises a D-pad 13 with four directional buttons, namely, down directional button 9, left arrow directional button 10, up directional button 11 and right directional button 12, and further comprises two contacts 65 which may be made of a copper alloy. The right controller/console 30 additionally comprises an X play button 14, Y play button 15, A play button 16 and B play button 17, and further two receiving ports (not shown) for receiving the contacts 65.

The Universal Game Controller/Console 1 is ergonomically designed for user comfort.

As seen in FIG. 4, the left and right controller/console 20,30 both have a power indicator LED light 150 to indicate that the power is on, a Bluetooth® indicator LED light 130 to indicate if Bluetooth® is active and a Wi-Fi indicator LED light 140 to indicate if Wi-Fi is active.

As shown in FIG. 5, the left and right controller/console 20, 30 both have a USB port 190 and heat vents 180. However, the USB port may only be on the left controller/console 20.

The Universal Game Controller/Console 10 is easily attached to any mobile or tablet via the universal clamping mechanism 110.

When the left and right controller/console 20, 30 halves are together the console is in one piece, the two contacts 65 are connected with the two receiving ports (not shown) and the charge gets transferred from one side to the other. As such it is only needed to have one micro USB slot on one side of the console for charging since the other side is charged through the contacts when inserted into the ports. USB connectivity charges the device as well as transferring data to a secondary memory for the user of the Universal Game Controller/Console. An audio jack (not shown) provides stereo audio through headphones.

The buttons on Universal Game Controller/Console can be classified into two parts depending on the usage and functionality. One set of buttons is used for gaming and the other for configuring functionality and connecting the Universal Game Controller/Console to a mobile or tablet. Universal Game Controller/Console connects with any screen through wireless mode.

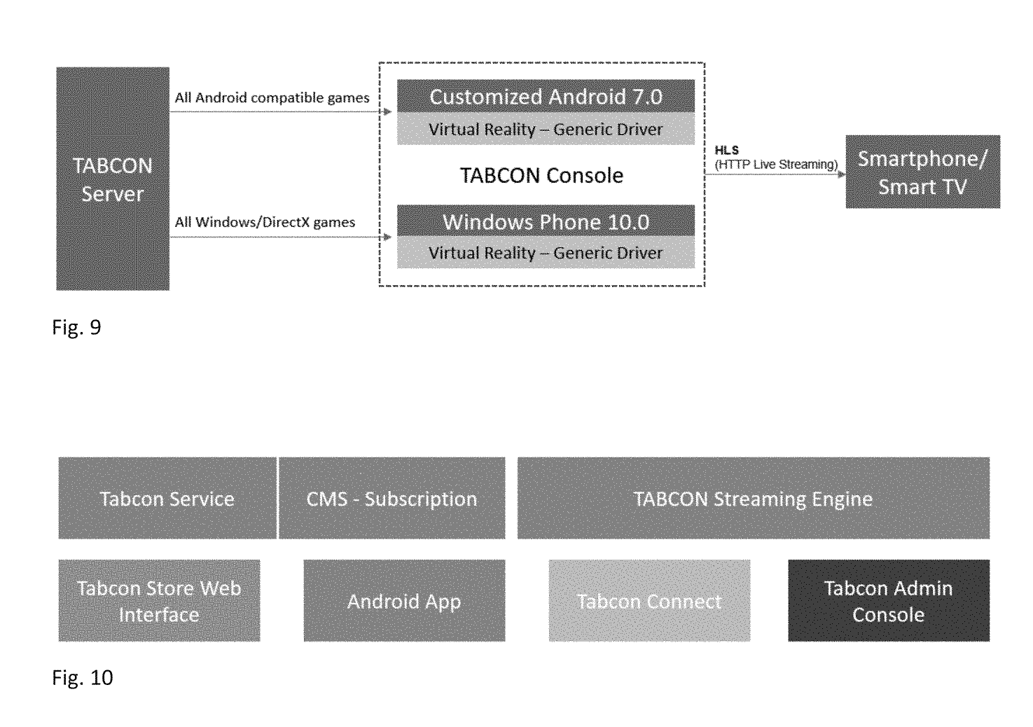

FIG. 9 shows the use of the Universal Game Controller/Console (“TABCON™ Console”) wherein a TABCON™ Server delivers Android® compatible or Windows/DirectX® games to the Universal Game Controller/Console for game user's play which is transmitted wirelessly to and viewed on a smartphone (held by the controller/consoles) or smart TV (separate from the controller/consoles).

### LEDs

The purpose of the LEDs in the Universal Game Controller/Console is to give visual indications to the user on the status of the device from switching on, Bluetooth status, pairing, Wi-Fi connection, connectivity issues and so on

In an embodiment of the invention, the left controller/console 20 (Side A) has the only Power Indicator LED 150 and the right controller/console 30 (Side B) has the only the Bluetooth® and Wi-Fi LED 130,140.

Turning the power on results in an LED going on (for example, green), a blinking Wi-Fi LED and blinking BLUETOOTH® LED indicates successful pairing and connections. However, a low battery is indicated by red blinking power LED and BLUETOOTH® LED, but one skilled in the art will understand that other colors may be used.

### Switches

### Power Button

This is a switch to turn on the device similar to a power ON/OFF button.

### Volume Button

The volume control of the device is a volume rocker switch, with up/down control of the volume. Vibration intensity is also controllable through this rocker switch

### Gameplay Buttons

The trigger button 50 is a press to trigger button which is a push button. The Side A (left controller/console 20) and Side B (right side controller/console 30) game control buttons are used to play the games and are in unison. Accelerometer chips in both controller/consoles translate the motions made by the user on the x, y and z-axis to the screen.

### Speakers

There are speakers 100 on each controller/console (side A and side B) to listen to the sounds of a game. The speaker volume is controlled through the volume up down rocker switch.

### Vibration Motor

There is one vibration motor (not shown) on both sides (side A and side B) to experience the shakes or knocks in the game. The intensity level is controlled through the volume rocker switch

### Glide Pad Sensor

The glide pad 80 in the device transforms the game play actions to the system. This serves for movement, trigger and all the standard actions in gaming. In an embodiment of the present invention there is a sealable glide pad having precise positioning ability and not having any moving parts and not requiring contact pressure

### Bluetooth®

Bluetooth® is used in this system to communicate between the side A and B (left and right controller/console 20, 30) as well as with any device connected/attached to the Universal Game Controller/Console 1. The Bluetooth® chipset is at least
Bluetooth® version 4.2 with backward compatibility for other older versions
Small form factor
Ultra low power consumption
Receiver sensitivity and selectivity
Compliance with worldwide radio regulations
Programmable power output
Low voltage operation
Minimum external components for the chip
Security of the communication
ESD tolerance
Minimum antenna footprint on the pcb
RoHS (Restriction of Hazardous Substances Directive) compliant chip
Mesh networking capabilities

A chipset that supports wireless functionality may be used, for example CC2640 from Texas instruments, or less preferably CC2650.

A network is established within the Bluetooth® devices to help enable the connection to be established simultaneously in Universal Game Controller/Console between side A and side B in addition to the communication with other devices. This is required since Bluetooth® by technology has been a point to point connection since its inception.

Technology such as Smart Mesh is used which defines an interoperable mesh networking solution using Bluetooth® Low Energy.

### Wi-Fi

Wi-Fi is the mode of connection for the Universal Game Controller/Console 1 to connect to the internet. Wi-Fi communication transfers all data traffic to the internet as well as between the left and right controller/consoles. The IEEE 802.11 standard is implemented and the Wi-Fi chipset has at least:
Supports common security modes
Integrated IPv4 TCP/IP stack with BSD socket APIs for simple Internet connectivity with any MCU
802.11b/g/n integrated radio
Ultra-low leakage
Good power management
Ultra low power consumption
Energy efficient when inactive or Enter low-power deep sleep
Receiver sensitivity and selectivity
Compliance with worldwide radio regulations
Good temperature profile/Thermal management
Minimum external components for the chip
ESD tolerance
Minimum antenna footprint on the pcb
RoHS compliant chip

For example, the CC3100MOD SimpleLink from Texas Instruments can be used. The CC3100MOD integrates all protocols for Wi-Fi and Internet, which greatly minimizes host MCU software requirements. With built-in security protocols, the CC3100MOD provides a robust and simple security experience. Additionally, the CC3100MOD is a complete platform solution. The Wi-Fi network processor subsystem features a Wi-Fi Internet-on-a-Chip and contains an additional dedicated ARM MCU that completely off-loads the host MCU. This subsystem includes an 802.11 b/g/n radio, baseband, and MAC with a powerful crypto engine for fast, secure Internet connections with 256-bit encryption. The CC3100MOD module supports Station, Access Point, and Wi-Fi Direct modes. The module also supports WPA2 personal and enterprise security and WPS 2.0.
Low-Power Consumption at 3.6 V
Hibernate With Real-Time Clock (RTC): 7 μA
Standby: 140 μA
RX Traffic: 54 mA at 54 OFDM
TX Traffic: 223 mA at 54 OFDM

### CPU

A NVidia® Tegra® 4i-ARM Cortex-A9 r4—Clock speed 2 GHz can be used, or a Qualcomm® Snapdragon® 820 MSM8996—Clock speed 2.2 GHz, or an Intel® Core™ m7-6Y75.

When not in use, the Universal Game Controller/Console can be detached from the mobile or tablet and stored in a small protective travel pouch.

### Software

The Universal Game Controller/Console (with streaming services) is a mobile game console that utilizes any screen giving a gamer a wide arena to play any game. Universal Game Controller/Console's operating system allows streaming of games cross-platform as well as to play any current game on the market. The Universal Game Controller/Console application bridges the gap between mobile and console gaming. The universality of the operating system opens up formerly and existing closed market systems. A cloud-based service that hosts the gaming content with a virtual pop-up application delivers content right to the user.

The front-end design is web and application based. This is where the users create their customizable community to connect with the world through gaming. It is a new form world gaming. Creating communities through multi-player interaction no matter what type of gaming type is preferred by the user-app games, PC/Online games, or console games.

### 24/7 Game Streaming

The Ability to Pay for Downloads when Gamers are Offline

Games for the Universal Game Controller/Console are licensed games from all game developers, and game developers may submit their games to the streaming game store.

The Universal Game Controller/Console offers two functions that are integrated into one. The first is the sleek and portable physical console. The second is integrated software that enhances mobile gaming.

Universal Game Controller/Console users may play as many games as they choose on any smart device, whether it is a tablet, phablet or smartphone. They may play new games launched on the service and have a wide library to choose from. The Universal Game Controller/Console gives users options of different genres, grades and styles of games through a large library. Users who download games may access the content even when their device is ‘offline’.

The Universal Game Controller/Console has three services available to the smart device gaming public. The first service is the “all-you-can-play” streaming subscription based service. This allows the subscriber to connect to the system through the app (either by Wi-Fi or a data connection) and the subscriber or user than has unlimited access to a complete library of games. This service is a monthly fee based model. Through the all-you-can-play service, users have the ability to download games into their personal library stored on the cloud. These games are available in their personal library as long as they subscribe to the service.

The second service is a mobile gaming download based service, which can be described as an “al la carte” service, allowing the user of this service to purchase games from a complete library when they would like to game offline. As an added feature of this service, games that users purchase are stored in a user's “cloud” account. The games offered on the streaming service are exclusive content that is only available through the Universal Game Controller/Console.

### Functional Requirements

As shown in FIG. 10, the software services available with the Universal Game Controller/Console consist of the following software modules:
1. TABCON™ Service: A versioned web API service layer with core business logic.
2. TABCON™ Streaming Service: For all real time streaming needs. TABCON™ Game streaming engine is the backbone of TABCON™ Cloud gaming/Gaming on demand service. Cloud gaming based on file streaming (progressive downloading) deploys a thin client in which the actual game is run on the user's Universal Game Controller/Console.
3. TABCON™ App: Mobile app showcases all TABCON™ games, search and filter options, initiates game services for the subscriber for iOS, Android and Windows. TABCON™ android app is the client app version of TABCON™ Store Web Interface—user may login, see the available games, saved/purchased games, top games, either download or stream games to play, buy games etc. TABCON™ app is exclusively for TABCON™ enhanced games which are available in the TABCON™ Cloud store. Top 10 Games, New/Updated Games, Popular Games, and Recommended for You, Try a Top Seller, From familiar faces, Adventure Games, New Game Releases categories help users to pick the right game for them. A separate category called ‘Featured’ lists the game advertisements.
4. TABCON™ Connect: TABCON™ Connect is a Web Interface for Game Developers to submit games, see sales dashboard, setup bank account etc.
5. TABCON™ Web Interface: is a Web extension of the TABCON™ Mobile App-Games are available through TABCON™ store either free of charge or at a cost. They are downloaded directly to a Universal Game Controller/Console through the TABCON™ Store mobile app, or by deploying the game to a Universal Game Controller/Console from the TABCON™ store website. User either downloads or streams games.
6. TABCON™ Admin Console: TABCON™ admin console provides dashboard analytics features for the admin. Data Mining; collecting data from users and streamed & downloaded games etc.

### TABCON™ Services

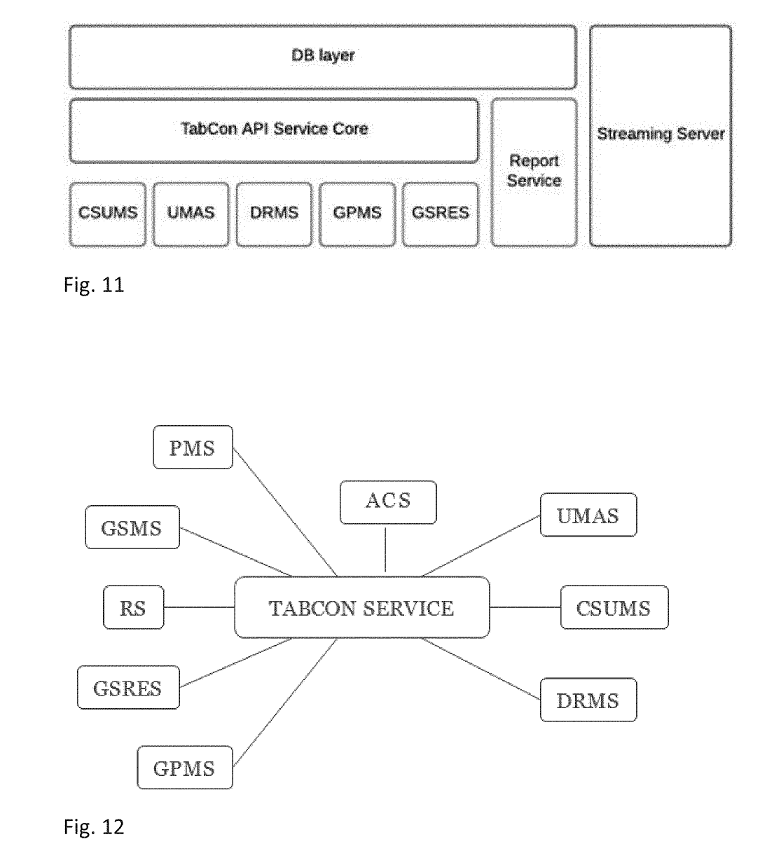

The software platform is shown in FIG. 11.

TABCON™ REST (“Representational State Transfer”) Web service is responsible for all business logic (including algorithm for game listing, sorting, rating, suggestion mechanism etc.), developer and subscriber accounts/profile management, payment gateway integration

### Configuration/Software Update Management Services—CSUMS

1. Dynamic parameters configuration based on geographic location, time, model, version etc.
2. Check for the device firmware version updates required.
3. Device validation locking/unlocking based on certain parameters.

### DEVICE REGISTRATION MANAGEMENT SERVICES—DRMS

1. Device registration for first time configuration and after reset
2. Managing device/user specific configuration remotely

### Game Publishing Management Services—GPMS

1. Publishing games
2. Publisher profile management
3. Agreement/Payment Configuration
4. Game Static Content Management
5. Price management
6. Game review and approval process

### Game Search and Recommendation Engine Services—GSRES

1. Searching games based on name, keywords etc.
2. Algorithm for recommending “You may also like” and “Customer also viewed” categories

### Report Services—RS

1. Real time data for currently active sessions
2. Finance reports
3. Active user and transaction report
4. TC devices reports

### Game Streaming Management Services—GSMS

1. API's for initiating streaming with the TABCON devices, IP-TV, Mobile Phones
2. Services/API's to support RTP/RTCP/HLS
3. Content Management and Delivery services are part of GSMS

### Payment Management Services—PMS

1. Integration with Payment Aggregators
2. Manage User Subscriptions

PMS takes care of the payment gateway integrations as well.

### Ad Campaign Services—ACS

1. Manage Game Developer's ad campaigns
2. APIs retrieve concerned Ads for each specific user
3. Ad Campaign Revenue and Analytics APIs

### TABCON™ Connect

TABCON™ Connect SDK is the core module in TABCON™ Connect.

### Connected Services—CSUMS—GSMS

1. SDK has “Must Implement” functions and as well as “Optional Functions”
2. Game after implementing the “Must Implement” functions becomes compatible with TABCON™ hardware
3. “Must Implement” has function to validate game with the server and also streaming support functions
4. “Optional Functions” are functions such as using central game score board, social network integration with TABCON™ social media sites.
5. This SDK with user manual is provided to the game publisher for integration

### TABCON™ Store—Web Interface

TABCON™ Store is the Web extension of the TABCON™ Mobile App—Games are available through TABCON™ store either free of charge or at a cost. They are downloaded directly to a Universal Game Controller/Console through the TABCON™ Store mobile app, or by deploying the game to a device from the TABCON™ store website. User can either download or stream games.

### TABCON™ Mobile Application Consumes the Following Services: CSUMS-DRMS-GSRES-GSMS-PMS.

1. Create/edit user profile
2. Pair with Universal Game Controller/Console using PIN/Pass Key
3. List/Search/View Games using GSES
4. View GDP—Game Detail Page
5. Download games to phone
6. Sync-up downloaded games to TABCON using Bluetooth® or Wi-Fi
7. Suggestions—“You may like” and “Customer also viewed” categories
8. Review/Rate the games
9. Direct connectivity with Universal Game Controller/Console using Wi-Fi for real time game streaming
10. Payment Integration—PMS
11. Client side caching optimizes the performance

### Admin Console

TABCON™ admin console provides dashboard analytics features for the administration, Data Mining collecting data from users and streamed and downloaded games etc.

### Screenshots

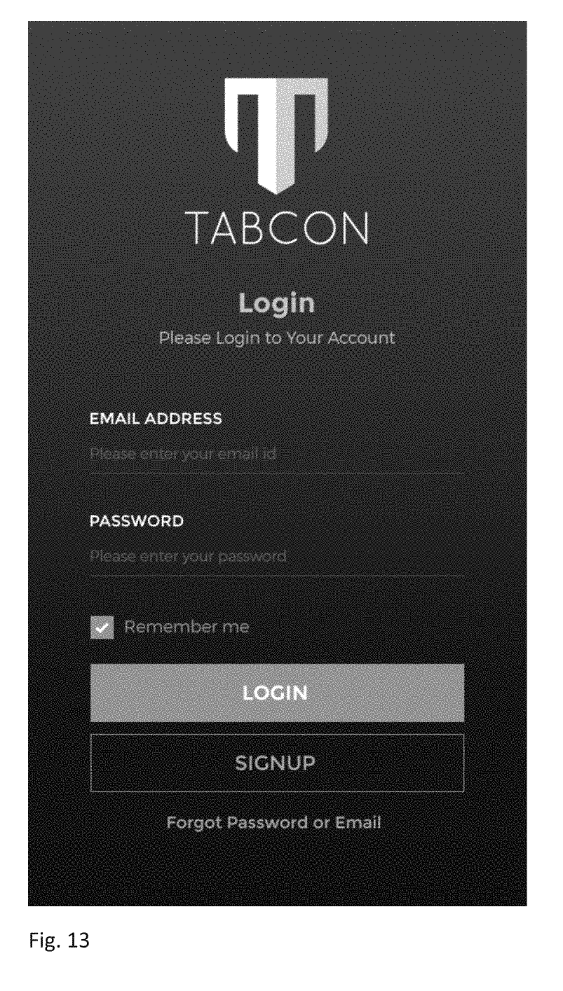

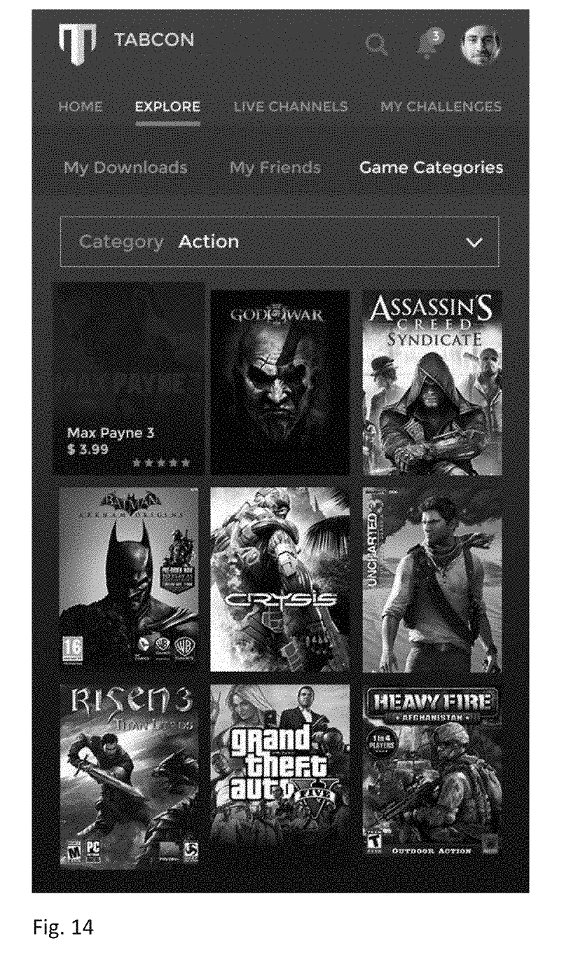

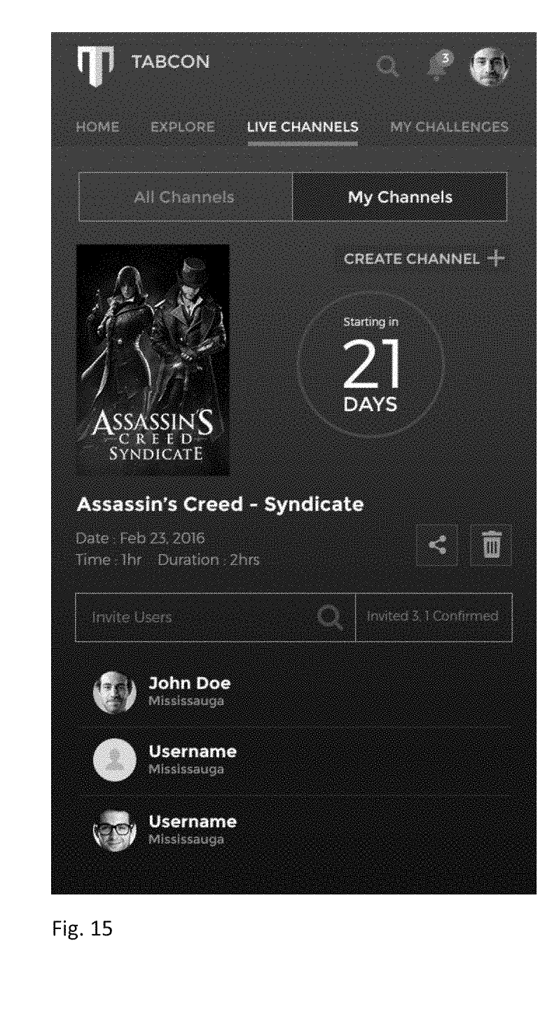

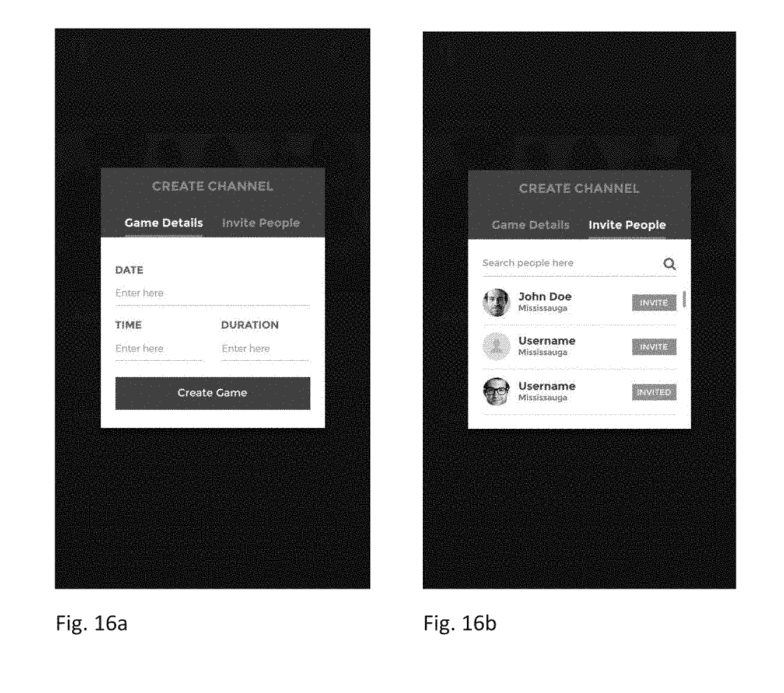

Demonstration screenshots are shown in FIGS. 13 to 16b.

### User Experience and UI

All web interfaces are fully responsive. Use Login Forms, Popup styles, Model and Modeless windows

### Material Design Pattern, Parallax Scrolling

### Font

Roboto Thin, Roboto Condensed, Robot Light Fonts are used throughout the application.

### Color Theme

### TABCON Connect

[symbol] ef6262 [symbol]
3d3c3c [symbol]
f7f6f6

### TABCON Store—Web Interface

[symbol] 3a97d0 [symbol]
3d3c3c [symbol]
f7f6f6
admin console [symbol]
3a97d0 [symbol]
3d3c3c [symbol]
f7f6f6

### TABCON Android Mobile app

[symbol] 3a97d0 [symbol]
3d3c3c [symbol]
f7f6f6

### Technologies

### Web UI

The most powerful HTML, CSS and JS framework with Sass (CSS pre-compiler) and single page UI MVC framework—Angular JS was used to develop the web interface (UI).

### Web API

RESTful, versioned web API service developed using Django-Python.

### Business Layer

The business layer handles the core backend logic in Python. Message Queue layer (Active MQ or Rabbit MQ) improves the backend performance.

### Database & In Memory Cache

PostgreSQL is the main database. The open source ‘Memcached’ is a cache for storing frequently used information to save (into RAM) from loading (and processing) information from slower sources, such as disks or a database as a dedicated situation or as a method of using up spare memory in an existing environment. The use of Memcached speeds up the application processes.

### Standards

Coding standard
Python: Standard coding guidelines
Google® Angular JS Style Guide
Apple iOS® Best Practice guidelines by Apple®
Android® Best Practice Guidelines by Google®

While embodiments of the invention have been described in the detailed description, the scope of the claims should not be limited by the preferred embodiments set forth in the examples, but should be given the broadest interpretation consistent with the description as a whole.

What is claimed is:

1. A game console which is both a console and controller.

2. The game console of claim 1 comprising a left controller/console and a right controller/console.

3. The game console of claim 2, in which the left controller/console and right controller/console each have a clamping mechanism for attachment to a display screen.

4. The game console of claim 2 in which the left controller/console and right controller/console together act as a controller for use with a separate display screen.

5. The game console of claim 1 which is comprised of a pair of game consoles for use in holding any portable device with a display screen between the pair of game consoles.

6. The game console of claim 6 in which the display screen is a tablet computer or mobile phone.

7. The game console of claim 2, in which the said left and right controller/consoles are sized to fit in the palm of a left hand and right hand; are slimmer at the midpoint, and additionally comprise play buttons from about the midpoint angling slightly outward to glide pad buttons.

8. The game console of claim 2, in which the said left and right controller/consoles each comprise a sealable glide pad having precise positioning ability and not having any moving parts and not requiring contact pressure.

9. The game console of claim 2, in which the left controller/console is chargeable and capable of charging the right controller/console.

10. The game console of claim 11, in the left controller/console comprises two tabs with metal contacts which fit into two receiving ports on the right controller/console for receiving charging.

11. A game console as disclosed herein.
